(19) United States
(12) Patent Application Publication
(10) Pub. No.: US 2012/0039647 A1
(43) Pub. Date: Feb. 16, 2012

(54) FIXING DEVICES INCLUDING EXTENDED-LIFE COMPONENTS AND METHODS OF FIXING MARKING MATERIAL TO SUBSTRATES

(75) Inventors: Grace T. BREWINGTON, Fairport, NY (US); Dale R. Mashtare, Bloomfield, NY (US); Anthony S. Condello, Webster, NY (US); Daniel M. Bray, Rochester, NY (US); Santokh Badesha, Pittsford, NY (US); James R. Beachner, Ontario, NY (US); Robert W. Phelps, Victor, NY (US); Richard W. Seyfried, Williamson, NY (US); Bin Zhang, Penfield, NY (US); Christopher G. Lynn, Wolcott, NY (US)

(73) Assignee: XEROX CORPORATION, Norwalk, CT (US)

(21) Appl. No.: 12/855,106

(22) Filed: Aug. 12, 2010

(51) Int. Cl. G03G 15/20

(52) U.S. Cl. 399/328

(57) ABSTRACT

Fixing devices including extended-life components and methods of fixing marking material to a substrate are provided. An exemplary embodiment of the fixing devices for fixing toner to a substrate in printing includes a first fixing member including a first surface; a thermal energy source for heating the first surface of the first fixing member to a fixing temperature; and a second fixing member including a second surface. The first surface and the second surface form a fixing nip configured to receive a substrate including a surface and marking material comprising toner disposed on the surface. The first fixing member and the second fixing member are operable to apply a pressure of at least about 300 psi to the substrate and toner and to heat the toner to a sufficiently-high temperature, at the fixing nip, to fix the toner to the substrate.

### RELATED APPLICATIONS

This application is related to the applications entitled “MULTI-STAGE FIXING SYSTEMS, PRINTING APPARATUSES AND METHODS OF FIXING MARKING MATERIAL TO SUBSTRATES” (Attorney Docket No. 056-0236); “FIXING DEVICES FOR FIXING MARKING MATERIAL TO A WEB WITH CONTACT PRE-HEATING OF WEB AND MARKING MATERIAL AND METHODS OF FIXING MARKING MATERIAL TO A WEB” (Attorney Docket No. 056-0238); “FIXING DEVICES INCLUDING LOW-VISCOSITY RELEASE AGENT APPLICATOR SYSTEM AND METHODS OF FIXING MARKING MATERIAL TO SUBSTRATES” (Attorney Docket No. 056-0242); “FIXING DEVICES INCLUDING CONTACT PRE-HEATER AND METHODS OF FIXING MARKING MATERIAL TO SUBSTRATES” (Attorney Docket No. 056-0252); “FIXING SYSTEMS INCLUDING IMAGE CONDITIONER AND IMAGE PRE-HEATER AND METHODS OF FIXING MARKING MATERIAL TO SUBSTRATES” (Attorney Docket No. 056-0255); and “LOW ADHESION COATINGS FOR IMAGE FIXING” (Attorney Docket No. 0010.0219), each of which is filed on the same date as the present application, commonly assigned to the assignee of the present application, and incorporated herein by reference in its entirety.

### BACKGROUND

In some printing apparatuses, toner is applied to substrates to form toner images. The toner images can be heated while being subjected to pressure to fix the toner to the substrates. In such apparatuses, harsh conditions that occur in the fixing device can cause components of the fixing devices to fail prematurely.

It would be desirable to provide robust printing apparatuses and methods of fixing marking material to a substrate in printing that can provide images with high quality with low operating cost.

### SUMMARY

Fixing devices including extended-life components and methods of fixing marking material to a substrate in printing are provided. An exemplary embodiment of a fixing device for fixing toner to a substrate in printing comprises a first fixing member including a first surface; a thermal energy source for heating the first surface of the first fixing member to a fixing temperature; and a second fixing member including a second surface. The first surface and the second surface form a fixing nip configured to receive a substrate including a surface and marking material comprising toner disposed on the surface. The first fixing member and the second fixing member are operable to apply a pressure of at least about 300 psi to the substrate and toner and to heat the toner to a sufficiently-high temperature, at the fixing nip, to fix the toner to the substrate.

### DRAWINGS

FIG. 1 illustrates mechanical and chemical interactions that may occur between components of a fixing device, toner and a release agent at a fixing nip.

FIG. 2 depicts an exemplary embodiment of a printing apparatus.

FIG. 3 depicts an exemplary embodiment of a fixing device.

FIG. 4 shows a differential scanning calorimetry scan of heat flow versus temperature for a toner material.

FIG. 5 shows a plot of fixing pressure versus fixing temperature to achieve a selected image fix level of a toner to uncoated paper with fixing devices that utilize high pressure and low temperature, low temperature and moderate pressure and high temperature and low pressure.

FIGS. 6A and 6B show contour plots of linear rub number for the substrate dwell time versus the temperature of the outer surface of the fixing roll at nip pressures of 400 psi and 750 psi, respectively.

FIGS. 7A, 7B and 7C show contour plots of linear rub number for the fixing nip pressure versus the temperature of the outer surface of the fixing roll at dwell times of 10 ms, 20 ms and 30 ms, respectively.

### DETAILED DESCRIPTION

The disclosed embodiments include fixing devices for fixing marking material to a substrate in printing. An exemplary embodiment of a fixing device for fixing toner to a substrate in printing comprises a first fixing member including a first surface; a thermal energy source for heating the first surface of the first fixing member to a fixing temperature; and a second fixing member including a second surface. The first surface and the second surface form a fixing nip configured to receive a substrate including a surface and marking material comprising toner disposed on the surface. The first fixing member and the second fixing member are operable to apply a pressure of at least about 300 psi to the substrate and toner and to heat the toner to a sufficiently-high temperature, at the fixing nip, to fix the toner to the substrate.

Another exemplary embodiment of the fixing devices for fixing toner to a substrate in printing comprises a first roll including a first surface comprising a metallic material, a ceramic material, a polymeric material or a composite material; a thermal energy source for heating the first surface of the first roll to a fixing temperature of about 50° C. to about 140° C.; and a second roll including a second surface comprising a metallic material, a ceramic material, a polymeric material or a composite material, the first surface and the second surface forming a fixing nip configured to receive a substrate including a surface and marking material comprising toner disposed on the surface. The first roll and second roll are operable to apply a pressure of about 300 psi to about 1500 psi to the substrate and toner and to heat the toner to a sufficiently-high temperature, at the fixing nip, to fix the toner to the substrate.

The disclosed embodiments further include methods of fixing toner to a substrate in printing. An exemplary embodiment of the methods comprises applying marking material comprising toner to a substrate with a marking device; feeding the substrate to a fixing device comprising a first fixing member including a first surface and a second fixing member including a second surface, the first surface and the second surface forming a fixing nip; heating the first surface of the first fixing member to a fixing temperature with a thermal energy source; and applying a pressure of at least about 300 psi to the substrate and toner and heating the toner to a sufficiently-high temperature with the heated first fixing member and the second fixing member, at the fixing nip, to fix the toner to the substrate.

Another exemplary embodiment of the methods of fixing toner to a substrate in printing comprises applying marking material comprising toner to a substrate with a marking device; feeding the substrate to a fixing device comprising a first roll including a first surface and a second roll including a second surface, the first surface comprising a metallic material, a ceramic material, a polymeric material, or a composite material, the second surface comprising a metallic material, a ceramic material, a polymeric material or a composite material, and the first surface and the second surface forming a fixing nip; heating the first surface of the first fixing member to a fixing temperature of about 50° C. to about 140° C. with a thermal energy source; and applying a pressure of about 300 psi to about 1500 psi to the substrate and toner and heating the toner to a sufficiently-high temperature with the heated first roll and the second roll at the fixing nip to fix the toner to the substrate.

In some printing processes, images are formed on substrates using marking material comprising dry toner. These printing processes may utilize a contact fixing device including fixing members that form a fixing nip. For example, one of the fixing members can include a fixing roll or a fixing belt and the other fixing member can include a pressure roll. In these fixing devices, a toner image formed on a substrate is fixed or fused by applying sufficient thermal energy and pressure to the substrate and toner image by contact with the fixing members at the fixing nip.

The fixing of toner onto a substrate can be achieved using high-temperature, low pressure conditions in contact fixing devices. These devices may utilize a roll or belt surface composed of elastomeric materials. In these devices, the elastomeric materials are typically subjected to high surface temperatures of 150° C. to 210° C. and relatively-low fixing nip pressures of 60 psi to 100 psi. At these temperature conditions, high-temperature-compatible elastomeric materials are required. These fixing devices are operated at these high temperatures to fix the toner material onto the substrate at the fixing nip in milliseconds of dwell time.

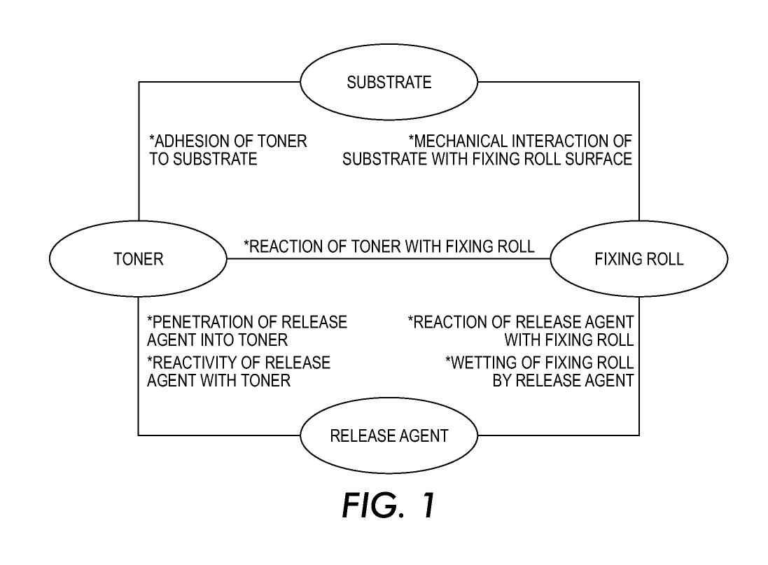

FIG. 1 depicts complex mechanical and chemical interactions that may occur between the substrate, toner, fixing roll and release agent applied to the fixing roll in a contact fixing device during the fixing of toner onto a substrate at a fixing nip. These interactions affect the machine performance and service life. The use of high fixing temperatures and reactive chemicals creates a harsh mechanical and chemical operating environment for exposed elastomeric materials of the fixing members. Despite the use of high-temperature-compatible elastomeric materials in these fixing devices, these harsh conditions commonly lead to the premature failure of the fixing members.

Another approach to fixing toner onto a substrate in printing includes non-contact fusing processes that heat the toner material by use of a radiant energy source with no pressure, or low pressure. These fusing processes rely upon radiant energy absorption and viscoelastic flow by the toner material resulting from irradiating the toner with radiant energy. It has been determined that this approach may produce limited image quality, introduces higher material costs due to additional property requirements placed upon the toner material, and also results in limited substrate compatibility.

Another approach to toner fixing in printing includes contact fixing processes that use high pressure at ambient temperature to fix the toner to a substrate. Although this approach may avoid high-temperature conditions at the fixing nip, it places additional requirements on the toner material to enable adequate fixing of the toner onto substrates and typically produces images with limited image quality, particularly in color printing processes.

As used herein, the term “printing apparatus” can encompass various types of apparatuses that are used to form images on substrates with marking materials. These apparatuses can include printers, copy machines, facsimile machines, multi-function machines, and the like.

In view of the above observations regarding mechanical and chemical interactions that may occur in a contact fixing device that utilizes high fixing temperatures, fixing devices, printing apparatuses and methods of fixing marking material comprising toner to a substrate in printing are provided. The fixing devices, printing apparatuses and methods utilize a novel regime of applied pressures and temperatures for fixing toner to a substrate. Embodiments of the fixing devices, printing apparatuses and methods can produce a high image quality output while enabling use of robust, long-life sub-system components. The fixing devices, printing apparatuses and methods subject toner material applied to a substrate to temperature and pressure conditions, at a fixing nip, that are effective to flow the toner and provide adequate coalescence and adhesion of the toner to the substrate. The fixing devices, printing apparatuses and methods can use low temperatures and moderate pressures at the fixing nip to achieve fixing of the toner.

By performing the toner fixing process at relatively lower temperatures, lower demands are placed on components of the fixing devices, enabling the application of robust, long-life components. In addition, the use of relatively lower temperatures and moderate pressures can relax demands on the toner material composition and properties. Embodiments of the fixing devices, printing apparatuses and methods can provide high image quality, a high level of printed image permanence, and reduced overall printing costs.

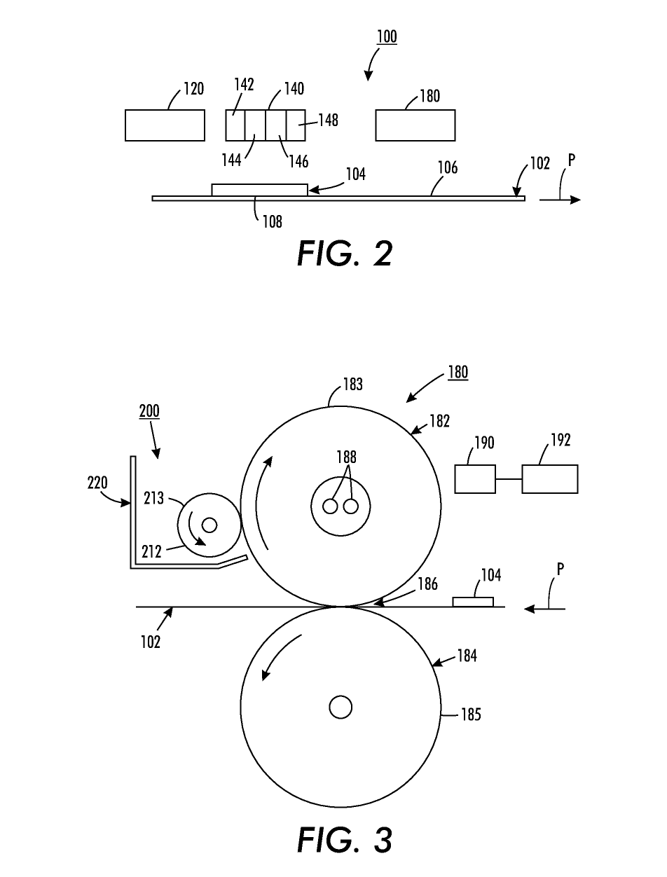

FIG. 2 depicts an exemplary embodiment of a printing apparatus 100 for forming images on a substrate 102. The substrate 102 is a sheet. Continuous webs may also be used as the substrate in the printing apparatus 100. The substrate 102 can comprise paper. The paper can be coated or uncoated. The substrate 102 may comprise packaging material. The printing apparatus 100 includes a substrate feeding device 120, a marking device 140 and a fixing device 180. The substrate 102 is fed by the substrate feeding device 120 to the marking device 140 to apply marking material 104 to a front surface 106 of the substrate 102. The marking material 104 comprises toner. The substrate 102 is then advanced to the fixing device 180 where sufficient thermal energy and pressure are applied to fix the toner to the front surface 106.

Embodiments of the marking device 140 can have any suitable configuration for applying marking material comprising toner to the substrate 102. In embodiments, the toner material comprises dry toner particles. The toner material may be a conventional toner or chemical toner. Carrier particles may be used to assist in delivery of the toner material in the printing apparatus 100. The marking device 140 can be constructed to apply marking material directly to the substrate 102 to form toner images. In other embodiments, the marking device 140 can be constructed to apply marking material first to an intermediate member, such as a roll or belt, and then to transfer the marking material from the intermediate member to the substrate 102.

The illustrated embodiment of the marking device 140 includes four marking stations 142, 144, 146 and 148 arranged in series along the process direction, P, of the printing apparatus 100. The marking stations 142, 144, 146 and 148 can each apply a marking material comprising a different color of toner, such as black, cyan, magenta and yellow toner, respectively, to the front surface 106 of the substrate 102 to form a color image. The marking device 140 can also be used to produce monochromatic images. While the marking device 140 is shown as applying marking material 104 to only the front surface 106 of the substrate 102, other embodiments of the printing apparatus 100 can be configured to produce duplex prints with substrates.

In embodiments of the printing apparatus 100, the substrate 102 and marking material 104 may be, or may not be, actively heated upstream of the fixing device 180. When the substrate 102 and marking material 104 are not actively heated before arriving at the fixing device 180, the substrate 102 and marking material 104 are typically at about the ambient temperature of the cavity of the printing apparatus 100 when the substrate 102 is received at the fixing device 180. At the fixing nip 186, the toner can be heated from ambient temperature to the desired temperature for fixing the toner to a substrate.

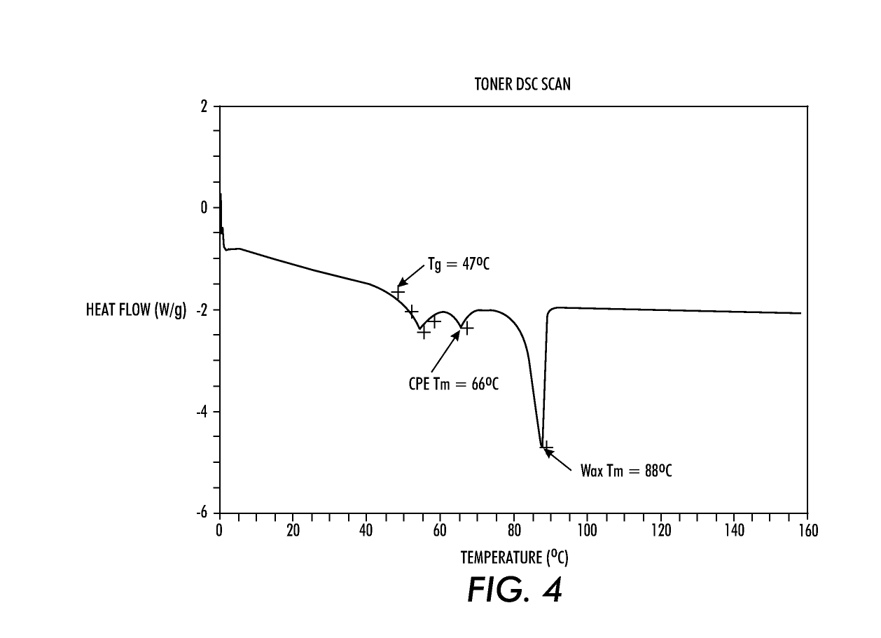

The fixing device 180 is constructed to heat the toner to a sufficiently-high temperature with applied pressure to cause the toner to coalesce and provide adequate adhesion of the image to the substrate 102. An exemplary embodiment of the fixing device 180 is shown in FIG. 3. The illustrated fixing device 180 includes a fixing roll 182 and a pressure roll 184. The fixing roll 182 contacts the pressure roll 184 to form the fixing nip 186. When the substrate 102 is received at the fixing nip 186, the substrate 102 and marking material 104 are heated and subjected to applied pressure by the fixing roll 182 and pressure roll 184.

In other embodiments, the fixing device may have a belt configuration for one or more of the fixing members. For example, a fixing belt can be entrained on one or more rolls and arranged with the pressure roll 184 to form the fixing nip. One or more rolls supporting the fixing belt may be heated to heat the fixing belt to the desired temperature.

The fixing roll 182 can be actively heated internally and/or externally by a thermal energy source. As shown, the thermal energy source can include one or more internal heating elements 188, such as axially-extending lamps, disposed inside of the fixing roll 182. The heating elements 188 are powered by a power supply 190 connected to the heating elements 188 to actively heat the outer surface 183 of the fixing roll 182 to the desired temperature for fixing toner to a substrate at the fixing nip 186. The power supply 190 is connected to a controller 192 configured to control the supply of power to the heating elements 188. In other embodiments, the outer surface 183 of the fixing roll 182 can alternatively, or additionally, be externally heated by a thermal energy source by conduction, convection and/or radiation. For example, at least one external heating roll can be provided in contact with the outer surface 183.

In embodiments, the outer surface 183 of the fixing roll 182 can comprise a metallic material, a ceramic material, or a composite material. For example, the fixing roll 182 can comprise an aluminum substrate that has been subjected to an anodizing treatment to convert the surface region of the substrate, including the outer surface 183, to porous anodized aluminum (aluminum oxide, Al₂O₃). The open pores of the anodized surface region can be impregnated with a suitable material to seal the open pores. For example, the open pores can be impregnated with a substance having lubricating properties, such as polytetrafluoroethylene (Teflon®), or the like, to seal the pores. The resulting outer surface 183 provides a desirable hardness and release properties. Following the sealing process, the outer surface 183 can be polished to a smooth finish.

To achieve uniform pressures at the fixing nip 186 along the longitudinal axis of the fixing roll 182 over the entire applied pressure range, the fixing roll 182 or the pressure roll 184 can be crowned.

In other embodiments, the fixing roll 182 can include one or more outer layers, each comprised of a polymer or a polymer composite material. In these embodiments, the outermost outer layer includes the outer surface 183. For example, the polymer can be polyurethane, nitrile butadiene rubber, or the like. Each outer layer can have a thickness of, e.g., about 1 mm to about 15 mm. In embodiments, it is desirable to minimize the thickness of the outer layer(s) to improve thermal conductivity and allow desirable fixing performance in the temperature range of about 50° C. to about 140° C. The outer layers can contain one or more filler materials to increase its thermal conductivity, improve durability and/or improve static charge buildup. The outer layer(s) can provide improved spreading of toner during the fixing process, as well as improved release performance by the fixing roll 182.

In the low-temperature, moderate-pressure regime in which the fixing device 180 can be operated, embodiments of the fixing roll 182 that include an outer surface 183 comprised of anodized aluminum, and embodiments that include one or more polymeric outer layers, provide resistance to the complex mechanical and chemical interactions that occur at the fixing nip 186 during fixing of toner to substrates.

In embodiments of the fixing device 180, the pressure roll 184 can comprise a core and a metallic material, a ceramic material, a composite material or a polymeric material that overlies the core and forms the outer surface 185. For example, the pressure roll 184 can comprise an aluminum substrate that has been anodized to convert the surface region of the substrate, including the outer surface 185, to porous anodized aluminum (aluminum oxide, Al₂O₃). The open pores of the anodized surface region can be impregnated with a suitable material to seal the open pores. For example, the open pores can be impregnated with a substance having lubricating properties, such as Teflon®, or the like, to seal the pores.

The polymeric material can be polyurethane, nitrile butadiene rubber, or the like. The polymeric material can be applied as a single layer, or as two or more layers. Different layers of the multi-layer constructions can have a different composition and properties from each other, e.g., a different elastic modulus. Each polymeric outer layer can have a thickness of, e.g., about 1 mm to about 15 mm. In embodiments, it is desirable to minimize the thickness of the outer layer(s) to improve thermal conductivity and allow desirable fixing performance in the temperature range of about 50° C. to about 140° C., for example. The outer layer(s) can contain a filler material to increase thermal conductivity, improve durability and/or improve static charge buildup. The outer layer(s) can provide improved spreading of toner during the fixing process, as well as improved release performance by the fixing roll 182. The pressure roll 184 may be heated.

In the fixing device 180, the outer surface 183 of the fixing roll 182 is heated to a temperature suitable for fixing the toner formulation to the substrate 102. In embodiments, the temperature of the outer surface 183 (i.e., the fixing temperature) can be set from about 50° C. to about 140° C., such as about 90° C. to about 140° C., or about 105° C. to about 130° C., for fixing the toner on the substrate 102. Increasing the pressure applied at the fixing device 180 can allow a lower fixing temperature to be used at the fixing nip 186 to fix toner to substrates.

In the printing apparatus 100, the fixing temperature of the fixing device 180 can be adjusted for different substrate materials and types. For example, for a heavy-weight paper substrate 102 (coated or uncoated), the fixing temperature can be increased at a given dwell as compared to fixing temperatures used for a light-weight paper substrate 102.

During fixing, the toner image is highly viscous. Sufficient pressure is applied at the fixing nip 186 to ensure adequate adhesion to the substrate and good coalescence for permanence and high image quality. Moderate pressures can be used at the fixing nip 186 to achieve adequate fixing of the toner. In embodiments, the amount of pressure applied to the substrate 102 at the fixing nip 186 can range from about 300 psi to about 3000 psi, such as about 300 psi to about 1500 psi, or about 400 psi to about 1000 psi.

In embodiments, in the fixing device 180, the pressure at the fixing nip 186 can be about 400 psi to about 1000 psi, and the fixing temperature can be about 90° C. to about 140° C. In other embodiments, the pressure at the fixing nip 186 can be about 400 psi to about 1000 psi, and the fixing temperature can be about 105° C. to about 130° C. In other embodiments, the pressure at the fixing nip 186 can be about 400 psi to about 700 psi, and the fixing temperature can be about 90° C. to about 140° C. In other embodiments, the pressure at the fixing nip 186 can be about 400 psi to about 700 psi, and the fixing temperature can be about 105° C. to about 130° C.

The temperature and pressure conditions used at the fixing device 180 can be selected based on the melting temperature of the toner material used to form prints. For example, in an embodiment, the fixing device 180 can be operated at a fixing temperature of about 90° C. to about 140° C. and a nip pressure of about 400 psi to about 700 psi to fix a first toner material to substrates. For a second toner material having a higher melting temperature than the first toner material, the fixing device 180 can be operated at a fixing temperature of about 105° C. to about 140° C. and a nip pressure of about 400 psi to about 1000 psi to fix the second toner material to substrates. In embodiments, the fixing temperature can be tuned to melt the toner material at the fixing nip.

As shown in FIG. 3, the fixing device 180 can include a release agent applicator system 200 to apply a release agent to the outer surface 183 of the fixing roll 182. The release agent is formulated to prevent adherence of toner to the fixing roll 182 and to assist in stripping of the substrate from the fixing roll following fixing. For example, the release agent can comprise silicone oil, such as a non-functionalized silicone oil, an amino-functional silicone oil, a fluoro-silicone oil, or a blend of two or more silicone oils. The illustrated release agent applicator system 200 includes a release agent applicator roll 212 having an outer surface 213. The applicator roll 212 is rotatable to apply release agent to the outer surface 183. A tray 220 is positioned to collect residual release agent.

The level of cohesion of toner particles may be measured using a linear rub test. In this test, after toner is fixed to a substrate to produce a print, a stylus covered with a selected cloth material is rubbed on the print. The stylus pressure is given by the ratio of the known stylus weight to the known stylus area over which the weight is applied. The stylus is moved a known distance over the print. In this test, toner will accumulate on the cloth for prints where the toner image is not completely fixed or fused on the substrate. After rubbing the print, the cloth is scanned with a scanner and the difference between the average gray level of the rubbed cloth and the gray level of a clean cloth is reported as the linear rub number. A lower linear rub number indicates better fixing or fusing of toner to a substrate. In an embodiment of the linear rub test, it is desirable for prints to have less than a maximum linear rub number of about 60, such as less than about 50, less than about 40, less than about 30, or less than about 20. For this embodiment, a linear rub number of less than about 40 indicates an excellent fix level of toner to a substrate.

In the fixing device 180, use of a relatively lower temperature at the fixing nip 186 can be further enabled through the use of low-melting and ultra-low-melting toner materials characterized as having a melting temperature that is altered (lowered) by heating the toner to a temperature above a threshold temperature and then re-heating the toner having the lowered melting temperature. Exemplary ultra-low-melting toners having these characteristics comprise a crystalline polymer material, such as crystalline polyester material, and an amorphous polymer material, such as amorphous polyester material, with the amorphous material having a glass transition temperature (T_{g}) separate from the melting temperature (Tₘ) of the crystalline material. In these toners, the crystalline polymer material imparts a low melting temperature to the toner. Exemplary toners having alterable melting temperature characteristics that may be used in the fixing device are disclosed in U.S. Pat. Nos. 7,402,371; 7,494,757 and 7,547,499, each of which is incorporated herein by reference in its entirety.

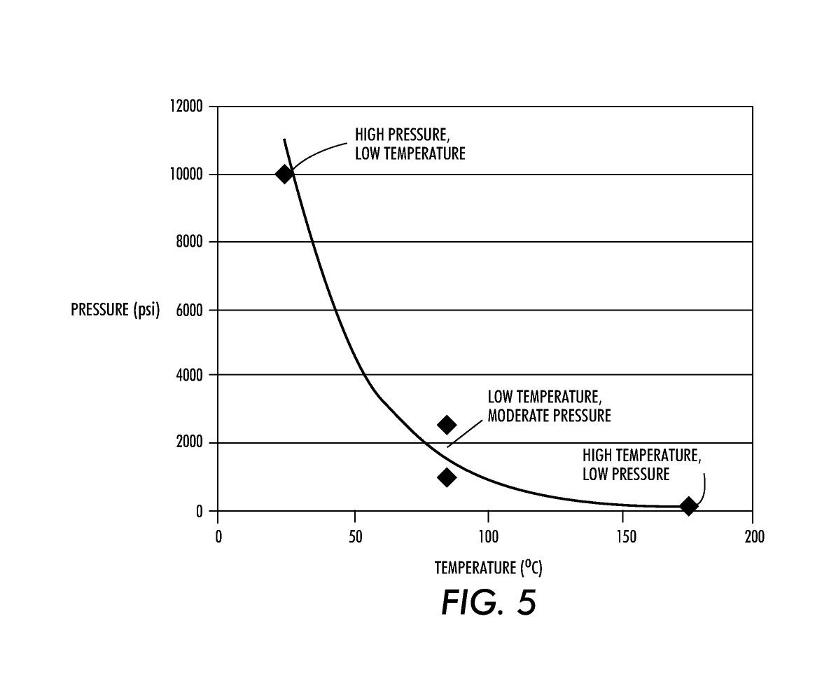

FIG. 4 shows a differential scanning calorimetry scan of heat flow versus temperature for a toner material having a low melting temperature. The toner contains a crystalline polyester resin, an amorphous polyester resin and a wax, and is cyan colored. As shown, the amorphous base resin has a glass transition onset temperature, T_{g}, of 47° C., the crystalline polyester resin has a melting temperature, CPE Tₘ, of 66° C., and the wax has a melting temperature, Wax Tₘ, of 88° C.

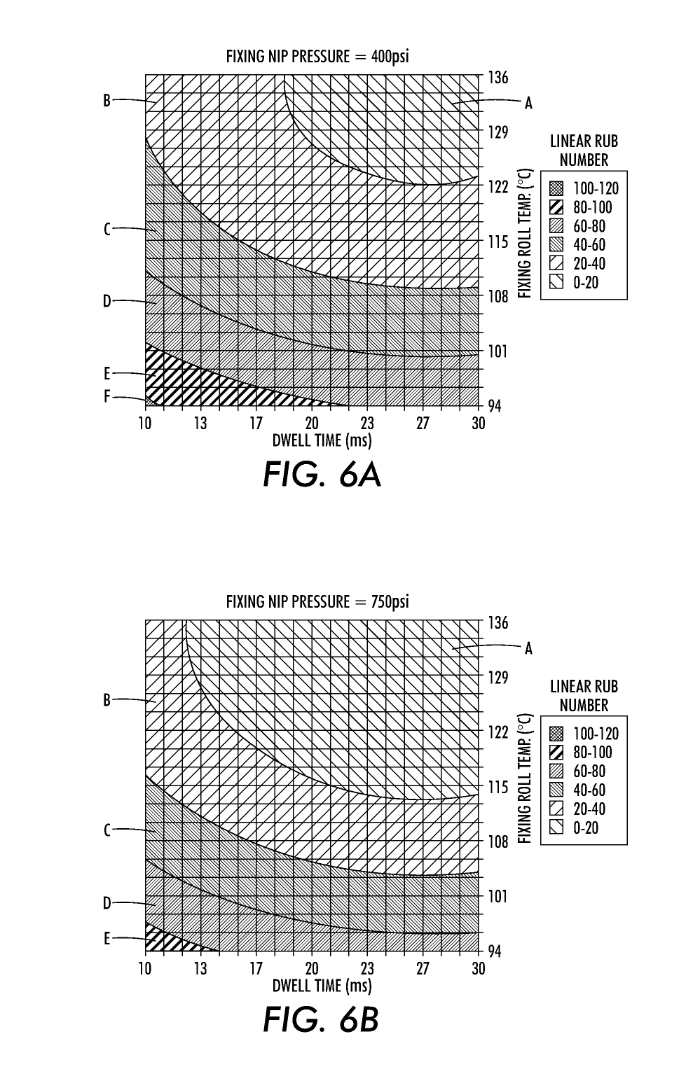

FIG. 5 shows a fixing nip pressure versus fixing temperature profile using the toner having a differential scanning calorimetry scan of heat flow versus temperature as shown in FIG. 4, used to achieve a particular image fix level as measured by the crease test. The data points in FIG. 5 represent a toner fixing process that uses low temperature and moderate pressure conditions at the fixing nip and, for comparison, a fixing process that uses low temperature (ambient temperature) and high pressure conditions, and a fixing process that uses high temperature and low pressure conditions.

Using a toner material having a low melting temperature allows the process conditions of temperature (thermal energy input), pressure and/or dwell (print speed) to be lowered in the fixing nip 186. Suitable toner materials may be expanded over other fusing approaches to provide optimal image quality, and low materials cost is enabled.

By operating at reduced toner temperatures in embodiments of the printing apparatuses, improved system/substrate path robustness without toner blocking problems in output stacks can be achieved.

As the operating set-points used in embodiments of the fixing devices and printing apparatuses accommodate low substrate temperatures, substrate distortion issues that can occur at elevated process temperatures can be avoided. This feature can extend the substrate application space achieved with xerographic printing systems. For example, polymeric film materials used in packaging may be used as the substrate in the fixing devices and printing apparatuses. The use of low operating temperatures also reduces or avoids water evaporation and reabsorption by paper and, consequently, can minimize or eliminate this potential source for paper distortion.

### EXAMPLES

### Example 1

A fixing device including a fixing roll and a pressure roll forming a fixing nip are used. The fixing roll is an aluminum roll having an anodized aluminum outer surface. The pressure roll includes an outer surface comprised of polyurethane. A light coating (˜1 mg/sheet) of release agent (Copy Aid silicone fluid manufactured by Wacker Chemical Corporation of Adrian, Mich.) is applied to the anodized aluminum surface. Xerox 4200 paper is used as the substrate. The toner contains styrene butyl acrylate resin and wax, and is black colored. The substrates are fed to the fixing nip of the fixing device and subjected to heating and pressure.

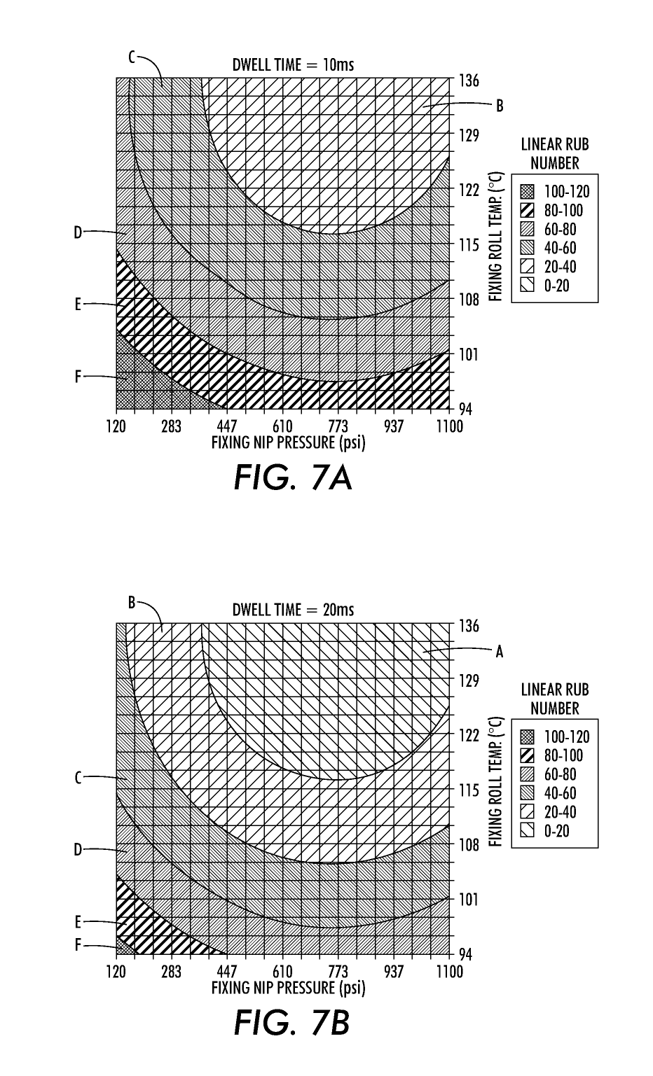

FIGS. 6A and 6B show contour plots of linear rub number for the substrate dwell time (i.e., amount to time for a substrate to pass through the fixing nip) versus the fixing roll temperature (outer surface) at nip pressures of 400 psi and 750 psi, respectively. These contour plots are generated by fitting experimental data to a mathematical model. A linear rub test is used to evaluate toner fix to the substrates. In this test, a stylus covered with a cloth material is rubbed on prints over a known length. The stylus has a known weight and area and exerts a know pressure on the prints. The cloth is scanned on a scanner and the difference between the average gray level of the rubbed cloth and the gray level of a clean cloth is reported as the linear rub number. For the linear rub test, a maximum linear rub number of about 60 is desirable, and a linear rub number of less than about 40 indicates an excellent fix level of toner to a substrate in a print.

Regions A, B, C, D, E and F are shown in the contour plots of FIGS. 6A and 6B. These respective regions encompass the following linear rub numbers: Region A: 0 to 20; Region B: 20 to 40; Region C: 40 to 60; Region D: 60 to 80; Region E: 80 to 100; and Region F: 100 to 120. In Example 1, Regions A and B encompass dwell time and fixing roll temperature values that provide less than a maximum linear rub number of 40. Comparing the contour plot in FIG. 6A to the contour plot in FIG. 6B shows that the size of Region A is increased, and Region B is extended to lower fixing roll temperatures at a given dwell time, by increasing the nip pressure. For example, for a dwell time of 20 ms, a linear rub number of 40 or less is achieved at a minimum fixing roll temperature of about 111° C. at a nip pressure of 400 psi (FIG. 6A), while a linear rub number of 40 or less is achieved at a lower minimum fixing roll temperature of about 105° C. at a nip pressure of 750 psi (FIG. 6B). As further shown in FIG. 6B, generally, when the dwell time is increased, a lower fixing roll temperature achieves less than a maximum linear rub number of 40.

### Example 2

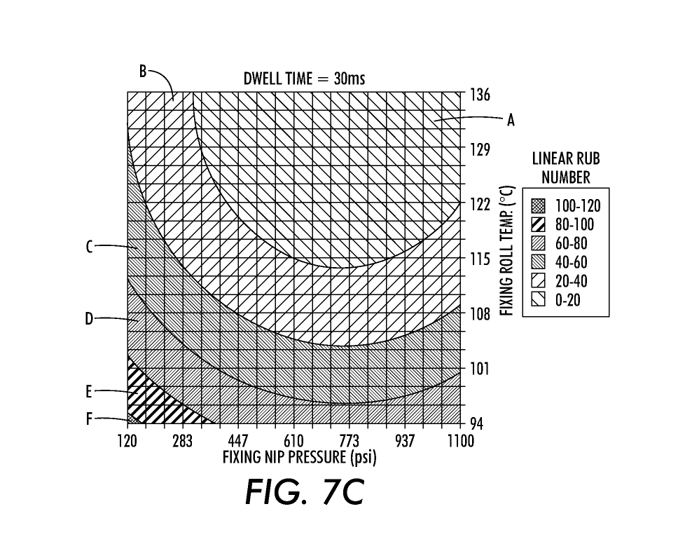

FIGS. 7A, 7B and 7C show contour plots of linear rub number for the fixing nip pressure versus the fixing roll temperature (outer surface) at dwell times of 10 ms, 20 ms and 30 ms, respectively. The contour plot of FIG. 7A includes regions B to F. The contour plots of FIGS. 7B and 7C include regions A to F. Regions A, B, C, D, E and F in FIGS. 7A, 7B and 7C encompass the same linear rub number ranges as Regions A, B, C, D, E and F, respectively, shown in FIGS. 6A and 6B.

Comparing the contour plot in FIG. 7A to the contour plot in FIG. 7B, shows that Region A results from increasing the dwell time from 10 ms to 20 ms, and Region B is extended to lower fixing roll temperatures at a given dwell time. Comparing the contour plot in FIG. 7B to the contour plot in FIG. 7C, by increasing the dwell time from 20 ms to 30 ms, Regions A and B are extended to lower fixing roll temperatures at a given dwell time.

### Example 3

A conventional thermal fixing device including a fixing roll and pressure roll are used. The conventional thermal fixing roll, which includes an elastomer-coated metal core, is replaced with an aluminum roll having an anodized outer aluminum surface. The pressure roll is not replaced and includes an outer surface comprised of an elastomer. A light coating (˜1 mg/sheet) of release agent (Copy Aid silicone fluid manufactured by Wacker Chemical Corporation of Adrian, Mich.) is applied to the anodized aluminum surface. Xerox 4200 paper is used as the substrate. The toner is the same as used in Example 1.

Fixing roll temperatures ranging from 100° C. to 220° C. are used. A nip pressure of 80 psi is achieved by increasing the load on the roll fixing nip. For a dwell time of 22 ms, a linear rub number of 40 or less is achieved at fixing roll temperatures of 175° C. and higher at the nip pressure of 80 psi. A linear rub number of greater than 40 is achieved at fixing roll temperatures lower than 175° C. A linear rub number of about 120 is achieved at a fixing roll temperature of about 110° C. A linear rub number of about 80 is achieved at a fixing roll temperature of about 140° C.

### Example 4

The same fixing device used in Example 3 is used. The fixing nip pressure is increased to 125 psi by increasing the load on the roll fixing nip in combination with reducing the active area of the fixing nip. Fixing roll temperatures ranging from 100° C. to 190° C. are used. For a dwell time of 22 ms, a linear rub number of 40 or less is achieved at fixing roll temperatures of 175° C. and higher at the nip pressure of 125 psi. A linear rub number greater than 40 is achieved at fixing roll temperatures lower than 175° C. A linear rub number of about 120 is achieved at a fixing roll temperature of about 110° C. A linear rub number of about 80 is achieved at a fixing roll temperature of about 140° C.

### Example 5

The same fixing device used in Example 3 is used. The nip pressure is increased by approximately doubling the applied load. The frames and loading mechanism did not have sufficient mechanical strength to support the increased load and the fixing device became inoperable. The frames could not support a nip pressure of about 125 psi for a full width roll.

It will be appreciated that various ones of the above-disclosed, as well as other features and functions, or alternatives thereof, may be desirably combined into many other different systems or applications. Also, various presently unforeseen or unanticipated alternatives, modifications, variations or improvements therein may be subsequently made by those skilled in the art, which are also intended to be encompassed by the following claims.

What is claimed is:

1. A fixing device for fixing toner to a substrate in printing, comprising:
a first fixing member including a first surface;
a thermal energy source for heating the first surface of the first fixing member to a fixing temperature; and
a second fixing member including a second surface, the first surface and the second surface form a fixing nip configured to receive a substrate including a surface and marking material comprising toner disposed on the surface;
wherein the first fixing member and the second fixing member are operable to apply a pressure of at least about 300 psi to the substrate and toner and to heat the toner to a sufficiently-high temperature, at the fixing nip, to fix the toner to the substrate.

2. The fixing device of claim 1, wherein:
the fixing temperature is about 50° C. to about 140° C.; and
the first fixing member and the second fixing member are operable to apply a pressure of about 300 psi to about 1500 psi to the substrate and toner at the fixing nip.

3. The fixing device of claim 1, wherein the thermal energy source is disposed inside of the first fixing member.

4. The fixing device of claim 1, wherein:
the first fixing member comprises a first roll including the first surface; and
the second fixing member comprises a second roll including the second surface.

5. The fixing device of claim 1, further comprising a release agent applicator system for applying a release agent to the first surface of the fixing member.

6. The fixing device of claim 1, wherein the toner comprises a crystalline polymer material and an amorphous polymer material, and the toner has a melting temperature which is lowered by heating the toner to a temperature above a threshold temperature.

7. A printing apparatus, comprising:
a fixing device according to claim 1; and
a marking device disposed upstream from the fixing device, the marking device comprising a plurality of marking stations, each marking station containing a supply of the marking material for applying to a substrate.

8. The printing apparatus of claim 7, wherein the substrate and toner are not actively heated upstream of the fixing device and are at about ambient temperature of a cavity of the printing apparatus when the substrate is received at the fixing nip.

9. A fixing device for fixing toner to a substrate in printing, comprising:
a first roll including a first surface comprising a metallic material, a ceramic material, a polymeric material or a composite material;
a thermal energy source for heating the first surface of the first roll to a fixing temperature of about 50° C. to about 140° C.; and
a second roll including a second surface comprising a metallic material, a ceramic material, a polymeric material or a composite material, the first surface and the second surface forming a fixing nip configured to receive a substrate including a surface and marking material comprising toner disposed on the surface;
wherein the first roll and second roll are operable to apply a pressure of about 300 psi to about 1500 psi to the substrate and toner and to heat the toner to a sufficiently-high temperature, at the fixing nip, to fix the toner to the substrate.

10. The fixing device of claim 9, wherein:
the first roll and the second roll are operable to apply a pressure of about 400 psi to about 1000 psi to the substrate and toner at the fixing nip;
the fixing temperature is about 90° C. to about 140° C.; and
the toner is melted at the fixing nip.

11. The fixing device of claim 9, wherein:
the first roll and the second roll are operable to apply a pressure of about 400 psi to about 1000 psi to the substrate and toner at the fixing nip;
the fixing temperature is about 105° C. to about 130° C.; and
the toner is melted at the fixing nip.

12. The fixing device of claim 9, wherein:
the first roll and the second roll are operable to apply a pressure of about 400 psi to about 700 psi to the substrate and toner at the fixing nip;
the fixing temperature is about 90° C. to about 140° C.; and
the toner is melted at the fixing nip.

13. The fixing device of claim 9, wherein:
the first roll and the second roll are operable to apply a pressure of about 400 psi to about 700 psi to the substrate and toner at the fixing nip;
the fixing temperature is about 105° C. to about 130° C.; and
the toner is melted at the fixing nip.

14. The fixing device of claim 9, wherein the first surface of the first roll comprises the metallic material, the ceramic material, or the composite material.

15. The fixing device of claim 14, wherein:
the first surface of the first roll comprises anodized aluminum; and
the second surface of the second roll comprises polyurethane.

16. The fixing device of claim 15, wherein the first surface of the first roll further comprises a lubricating material.

17. The fixing device of claim 9, wherein:
the first roll comprises at least one outer layer comprising polyurethane; and
the second surface of the second roll comprises polyurethane.

18. The fixing device of claim 9, further comprising a release agent applicator system for applying a release agent to the first surface of the fixing member.

19. The fixing device of claim 9, wherein the toner comprises a crystalline polymer material and an amorphous polymer material, and the toner has a melting temperature which is lowered by heating the toner to a temperature above a threshold temperature.

20. A printing apparatus, comprising:
a fixing device according to claim 9; and
a marking device disposed upstream from the fixing device, the marking device comprising a plurality of marking stations, each marking station containing a supply of the marking material for applying to a substrate.

21. The printing apparatus of claim 20, wherein the toner comprises a crystalline polymer material and an amorphous polymer material, and the toner has a melting temperature which is lowered by heating the toner to a temperature above a threshold temperature.

22. The printing apparatus of claim 20, wherein the substrate and toner are not actively heated upstream of the fixing device and are at about ambient temperature of a cavity of the printing apparatus when the substrate is received at the fixing nip.

23. A method of fixing toner to a substrate in printing, comprising:
applying marking material comprising toner to a substrate with a marking device;
feeding the substrate to a fixing device comprising a first fixing member including a first surface and a second fixing member including a second surface, the first surface and the second surface forming a fixing nip;
heating the first surface of the first fixing member to a fixing temperature with a thermal energy source; and
applying a pressure of at least about 300 psi to the substrate and toner and heating the toner to a sufficiently-high temperature with the heated first fixing member and the second fixing member, at the fixing nip, to fix the toner to the substrate.

24. The method of claim 23, wherein the toner (i) comprises a crystalline polymer material and an amorphous polymer material, (ii) has a melting temperature which is lowered by heating the toner to a temperature above a threshold temperature and (iii) is heated to a temperature above the melting temperature at the fixing nip.

25. The method of claim 23, wherein the substrate and toner are at about ambient temperature of a cavity of a printing apparatus comprising the fixing device when the substrate is fed to the fixing device.

26. The method of claim 23, further comprising applying a release agent comprising silicone oil to the first surface of the fixing member.

27. A method of fixing toner to a substrate in printing, comprising:
applying marking material comprising toner to a substrate with a marking device;
feeding the substrate to a fixing device comprising a first roll including a first surface and a second roll including a second surface, the first surface comprising a metallic material, a ceramic material, a polymeric material, or a composite material, the second surface comprising a metallic material, a ceramic material, a polymeric material or a composite material, and the first surface and the second surface forming a fixing nip;
heating the first surface of the first fixing member to a fixing temperature of about 50° C. to about 140° C. with a thermal energy source; and
applying a pressure of about 300 psi to about 1500 psi to the substrate and toner and heating the toner to a sufficiently-high temperature with the heated first roll and the second roll at the fixing nip to fix the toner to the substrate.

28. The method of claim 27, wherein:
the first fixing roll and the second fixing roll apply a pressure of about 400 psi to about 1000 psi to the substrate and toner at the fixing nip;
the fixing temperature is about 90° C. to about 140° C.; and
the toner is melted at the fixing nip.

29. The method of claim 27, wherein:
the first fixing roll and the second fixing roll apply a pressure of about 400 psi to about 1000 psi to the substrate and toner at the fixing nip;
the fixing temperature is about 105° C. to about 130° C.; and
the toner is melted at the fixing nip.

30. The method of claim 27, wherein:
the first fixing roll and the second fixing roll apply a pressure of about 400 psi to about 700 psi to the substrate and toner at the fixing nip;
the fixing temperature is about 90° C. to about 140° C.; and
the toner is melted at the fixing nip.

31. The method of claim 27, wherein:
the first fixing roll and the second fixing roll apply a pressure of about 400 psi to about 700 psi to the substrate and toner at the fixing nip;
the fixing temperature is about 105° C. to about 130° C.; and
the toner is melted at the fixing nip.

32. The method of claim 27, wherein the toner (i) comprises a crystalline polymer material and an amorphous polymer material, (ii) has a melting temperature which is lowered by heating the toner to a temperature above a threshold temperature and (iii) is heated to a temperature above the melting temperature at the fixing nip.

33. The method of claim 27, wherein the first surface of the first roll comprises the metallic material, the ceramic material, or the composite material.

34. The method of claim 33, wherein:
the first surface of the first roll comprises anodized aluminum; and
the second surface of the second roll comprises polyurethane.

35. The method of claim 34, wherein the first surface of the first roll further comprises a lubricating material.

36. The method of claim 27, wherein:
the first roll comprises at least one outer layer comprising polyurethane; and
the second surface of the second roll comprises polyurethane.

37. The method of claim 27, further comprising applying a release agent comprising silicone oil to the first surface of the fixing member.

38. The method of claim 37, wherein the silicone oil is selected from the group consisting of a non-functionalized silicone oil, an amino-functional silicone oil, a fluoro-silicone oil, and a blend of two or more silicone oils.

39. The method of claim 27, wherein the substrate and toner are not actively heated upstream of the fixing device and are at about ambient temperature of a cavity of a printing apparatus comprising the fixing device when the substrate is fed to the fixing device.

40. The method of claim 39, wherein the second roll is not actively heated.

41. The method of claim 27, wherein the substrate comprises paper.

42. The method of claim 27, wherein the substrate comprises a polymeric film.
